(19) United States
(12) Patent Application Publication
(10) Pub. No.: US 2026/0238777 A1
(43) Pub. Date: Aug. 13, 2026

(54) Method and Apparatus of Chroma ALF with Residual Taps in Video Coding System

(71) Applicant: MEDIATEK INC., Hsinchu City (TW)

(72) Inventors: Yu-Ling HSIAO, Hsinchu City (TW); Shih-Chun Chiu, Hsinchu City (TW); Yu-Cheng LIN, Hsinchu City (TW); Chih-Wei HSU, Hsinchu City (TW); Ching-Yeh CHEN, Hsinchu City (TW); Tzu-Der CHUANG, Hsinchu City (TW); Yi-Wen CHEN, San Jose, CA (US); Yu-Wen HUANG, Hsinchu City (TW)

(21) Appl. No.: 19/471,802

(22) PCT Filed: Apr. 3, 2024
(86) PCT No.: PCT/CN2024/085958

§ 371 Date: Oct. 2, 2025

Related U.S. Application Data
(60) Provisional application No. 63/498,851, filed on Apr. 28, 2023.

(51) Int. Cl. H04N 19/117; H04N 19/132; H04N 19/136; H04N 19/176; H04N 19/186

(52) U.S. Cl. CPC H04N 19/117; H04N 19/132; H04N 19/136; H04N 19/176; H04N 19/186

(57) ABSTRACT

Method and apparatus to use residual inputs for chroma ALF and/or CCALF are disclosed. According to this method, reconstructed data associated with a current block comprising a luma block and one or more chroma blocks are received. a chroma ALF (Adaptive Loop Filter), a Cross-Component ALF (CCALF), or both are determined, wherein the chroma ALF, the CCALF, or both comprise at least one first filter tap associated with a luma residual sample, at least one second filter tap associated with a chroma residual sample, or both. One or more filtered chroma samples are derived by applying the chroma ALF, the CCALF or both to the luma block, said one or more chroma blocks, or both. Said one or more filtered chroma samples are provided.

### CROSS REFERENCE TO RELATED APPLICATIONS

The present invention is a non-Provisional Application of and claims priority to U.S. Provisional Patent Application No. 63/498,851, filed on Apr. 28, 2023. The U.S. Provisional Patent Application is hereby incorporated by reference in its entirety.

### FIELD OF THE INVENTION

The present invention relates to video coding systems. In particular, the present invention relates to new techniques to design chroma ALF (Adaptive Loop Filter) or Cross-Component ALF by incorporating residual inputs.

### BACKGROUND AND RELATED ART

Versatile video coding (VVC) is the latest international video coding standard developed by the Joint Video Experts Team (JVET) of the ITU-T Video Coding Experts Group (VCEG) and the ISO/IEC Moving Picture Experts Group (MPEG). The standard has been published as an ISO standard: ISO/IEC 23090-3:2021, Information technology—Coded representation of immersive media—Part 3: Versatile video coding, published February 2021. VVC is developed based on its predecessor HEVC (High Efficiency Video Coding) by adding more coding tools to improve coding efficiency and also to handle various types of video sources including 3-dimensional (3D) video signals.

FIG. 1A illustrates an exemplary adaptive Inter/Intra video encoding system incorporating loop processing. For Intra Prediction 110, the prediction data is derived based on previously encoded video data in the current picture. For Inter Prediction 112, Motion Estimation (ME) is performed at the encoder side and Motion Compensation (MC) is performed based on the result of ME to provide prediction data derived from other picture(s) and motion data. Switch 114 selects Intra Prediction 110 or Inter-Prediction 112 and the selected prediction data is supplied to Adder 116 to form prediction errors, also called residues. The prediction error is then processed by Transform (T) 118 followed by Quantization (Q) 120. The transformed and quantized residues are then coded by Entropy Encoder 122 to be included in a video bitstream corresponding to the compressed video data. The bitstream associated with the transform coefficients is then packed with side information such as motion and coding modes associated with Intra prediction and Inter prediction, and other information such as parameters associated with loop filters applied to underlying image area. The side information associated with Intra Prediction 110, Inter prediction 112 and in-loop filter 130, are provided to Entropy Encoder 122 as shown in FIG. 1A. When an Inter-prediction mode is used, a reference picture or pictures have to be reconstructed at the encoder end as well. Consequently, the transformed and quantized residues are processed by Inverse Quantization (IQ) 124 and Inverse Transformation (IT) 126 to recover the residues. The residues are then added back to prediction data 136 at Reconstruction (REC) 128 to reconstruct video data. The reconstructed video data may be stored in Reference Picture Buffer 134 and used for prediction of other frames.

As shown in FIG. 1A, incoming video data undergoes a series of processing in the encoding system. The reconstructed video data from REC 128 may be subject to various impairments due to a series of processing. Accordingly, in-loop filter 130 is often applied to the reconstructed video data before the reconstructed video data are stored in the Reference Picture Buffer 134 in order to improve video quality. For example, deblocking filter (DF), Sample Adaptive Offset (SAO) and Adaptive Loop Filter (ALF) may be used. The loop filter information may need to be incorporated in the bitstream so that a decoder can properly recover the required information. Therefore, loop filter information is also provided to Entropy Encoder 122 for incorporation into the bitstream. In FIG. 1A, Loop filter 130 is applied to the reconstructed video before the reconstructed samples are stored in the reference picture buffer 134. The system in FIG. 1A is intended to illustrate an exemplary structure of a typical video encoder. It may correspond to the High Efficiency Video Coding (HEVC) system, VP8, VP9, H.264 or VVC.

The decoder, as shown in FIG. 1B, can use similar or portion of the same functional blocks as the encoder except for Transform 118 and Quantization 120 since the decoder only needs Inverse Quantization 124 and Inverse Transform 126. Instead of Entropy Encoder 122, the decoder uses an Entropy Decoder 140 to decode the video bitstream into quantized transform coefficients and needed coding information (e.g. ILPF information, Intra prediction information and Inter prediction information). The Intra prediction 150 at the decoder side does not need to perform the mode search. Instead, the decoder only needs to generate Intra prediction according to Intra prediction information received from the Entropy Decoder 140. Furthermore, for Inter prediction, the decoder only needs to perform motion compensation (MC 152) according to Inter prediction information received from the Entropy Decoder 140 without the need for motion estimation.

According to VVC, an input picture is partitioned into non-overlapped square block regions referred as CTUs (Coding Tree Units), similar to HEVC. Each CTU can be partitioned into one or multiple smaller size coding units (CUs). The resulting CU partitions can be in square or rectangular shapes. Also, VVC divides a CTU into prediction units (PUs) as a unit to apply prediction process, such as Inter prediction, Intra prediction, etc.

### Adaptive Loop Filter in VVC

In VVC, an Adaptive Loop Filter (ALF) with block-based filter adaption is applied. For the luma component, one filter is selected among 25 filters for each 4×4 block, based on the direction and activity of local gradients.

### Filter Shape

Two diamond filter shapes (as shown in FIG. 2) are used. The 7×7 diamond shape 220 is applied for luma component and the 5×5 diamond shape 210 is applied for chroma components.

### Block Classification

For luma component, each 4×4 block is categorized into one out of 25 classes. The classification index C is derived based on its directionality D and a quantized value of activity Â, as follows:

$$C = 5 D + \hat{A} .$$

To calculate D and Â, gradients of the horizontal, vertical and two diagonal direction are first calculated using 1-D Laplacian:

$${g}_{v} = {\sum }_{k = i - 2}^{i + 3} {\sum }_{l = j - 2}^{j + 3} {V}_{k , l} , {V}_{k , l} = \vert 2 R ( k , l ) - R ( k , l - 1 ) - R ( k , l + 1 ) \vert ,$$

$${g}_{h} = {\sum }_{k = i - 2}^{i + 3} {\sum }_{l = j - 2}^{j + 3} {H}_{k , l} , {H}_{k , l} = \vert 2 R ( k , l ) - R ( k - 1 , l ) - R ( k + 1 , l ) \vert ,$$

$${g}_{d 1} = {\sum }_{k = i - 2}^{i + 3} {\sum }_{l = j - 3}^{j + 3} D {1}_{k , l} , D {1}_{k , l} = \vert 2 R ( k , l ) - R ( k - 1 , l - 1 ) - R ( k + 1 , l + 1 ) \vert ,$$

$${g}_{d 2} = {\sum }_{k = i - 2}^{i + 3} {\sum }_{j = j - 2}^{j + 3} D {2}_{k , l} , D {2}_{k , l} = \vert 2 R ( k , l ) - R ( k - 1 , l + 1 ) - R ( k + 1 , l - 1 ) \vert ,$$

where indices i and j refer to the coordinates of the upper left sample within the 4×4 block and R(i,j) indicates a reconstructed sample at coordinate (i,j).

To reduce the complexity of block classification, the subsampled 1-D Laplacian calculation is applied to the vertical direction (FIG. 3A) and the horizontal direction (FIG. 3B). As shown in FIGS. 3C-D, the same subsampled positions are used for gradient calculation of all directions (g_{d1} in FIG. 3C and g_{d2} in FIG. 3D).

Then D maximum and minimum values of the gradients of horizontal and vertical directions are set as:

$${g}_{h , v}^{max} = max ( {g}_{h} , {g}_{v} ) , {g}_{h , v}^{min} = min ( {g}_{h} , {g}_{v} ) .$$

The maximum and minimum values of the gradient of two diagonal directions are set as:

$${g}_{d 0 , d 1}^{max} = max ( {g}_{d 0} , {g}_{d 1} ) , {g}_{d 0 , d 1}^{min} = min ( {g}_{d 0} , {g}_{d 1} ) .$$

To derive the value of the directionality D, these values are compared against each other and with two thresholds t₁ and t₂:
Step 1. If both

$${g}_{h , v}^{max} \leq {t}_{1} \cdot {g}_{h , v}^{min} and {g}_{d 0 , d 1}^{max} \leq {t}_{1} \cdot {g}_{d 0 , d 1}^{min}$$

are true, D is set to 0.
Step 2. If

$${g}_{h , v}^{max} / {g}_{h , v}^{min} > {g}_{d 0 , d 1}^{max} / {g}_{d 0 , d 1}^{min} ,$$

continue from Step 3; otherwise continue from Step 4.
Step 3. If

$${g}_{h , v}^{max} > {t}_{2} \cdot {g}_{h , v}^{min} ,$$

D is set to 2; otherwise D is set to 1.
Step 4. If

$${g}_{d 0 , d 1}^{max} > {t}_{2} \cdot {g}_{d 0 , d 1}^{min} ,$$

D is set to 4; otherwise D is set to 3.

The activity value A is calculated as:

$$A = {\sum }_{k = i - 2}^{i + 3} {\sum }_{l = j - 2}^{j + 3} ( {V}_{k , l} + {H}_{k , l} ) .$$

A is further quantized to the range of 0 to 4, inclusively, and the quantized value is denoted as Â.

For chroma components in a picture, no classification is applied.

Geometric transformations of filter coefficients and clipping values

Before filtering each 4×4 luma block, geometric transformations such as rotation or diagonal and vertical flipping are applied to the filter coefficients f(k, l) and to the corresponding filter clipping values c(k, l) depending on gradient values calculated for that block. This is equivalent to applying these transformations to the samples in the filter support region. The idea is to make different blocks to which ALF is applied more similar by aligning their directionality.

Three geometric transformations, including diagonal, vertical flip and rotation are introduced:

$$Diagonal : {f}_{D} ( k , l ) = f ( l , k ) , {c}_{D} ( k , l ) = c ( l , k ) ,$$

$$Vertical flip : {f}_{V} ( k , l ) = f ( k , K - l - 1 ) , {c}_{V} ( k , l ) = c ( k , K - l - 1 ) ,$$

$$Rotation : {f}_{R} ( k , l ) = f ( K - l - 1 , k ) , {c}_{R} ( k , l ) = c ( K - l - 1 , k ) ,$$

where K is the size of the filter and 0≤k, l≤K−1 are coefficients coordinates, such that location (0,0) is at the upper left corner and location (K−1, K−1) is at the lower right corner. The transformations are applied to the filter coefficients f (k, l) and to the clipping values c(k, l) depending on gradient values calculated for that block. The relationship between the transformation and the four gradients of the four directions are summarized in the following table.

TABLE 1
Mapping of the gradient calculated for
one block and the transformations

| Gradient values | Transformation | Transpose indexes |
|---|---|---|
| g_{d2} < g_{d1} and gₕ < gᵥ | No transformation | 0 |
| g_{d2} < g_{d1} and gᵥ < gₕ | Diagonal | 1 |
| g_{d1} < g_{d2} and gₕ < gᵥ | Vertical flip | 2 |
| g_{d1} < g_{d2} and gᵥ < gₕ | Rotation | 3 |

### Filtering Process

At decoder side, when ALF is enabled for a CTB, each sample R(i,j) within the CU is filtered, resulting in sample value R′(i,j) as shown below,

$${R}^{′} ( i , j ) = R ( i , j ) + ( ( {\sum }_{k \neq 0} {\sum }_{l \neq 0} f ( k , l ) \times K ( R ( i + k , j + l ) - R ( i , j ) , c ( k , l ) ) + 64 ) >> 7. )$$

where f(k, l) denotes the decoded filter coefficients, K(x, y) is the clipping function and c(k, l) denotes the decoded clipping parameters. The variable k and l vary between −L/2 and L/2, where L denotes the filter length. The clipping function K(x, y)=min(y, max(−y, x)) which corresponds to the function Clip3 (−y, y, x). The clipping operation introduces non-linearity to make ALF more efficient by reducing the impact of neighbour sample values that are too different with the current sample value.

### Cross Component Adaptive Loop Filter (CC-ALF)

CC-ALF (or CCALF) uses luma sample values to refine each chroma component by applying an adaptive, linear filter to the luma channel and then using the output of this filtering operation for chroma refinement. FIG. 4A provides a system level diagram of the CC-ALF process with respect to the SAO, luma ALF and chroma ALF processes. As shown in FIG. 4A, each colour component (i.e., Y, Cb and Cr) is processed by its respective SAO (i.e., SAO Luma 410, SAO Cb 412 and SAO Cr 414). After SAO, ALF Luma 420 is applied to the SAO-processed luma and ALF Chroma 430 is applied to SAO-processed Cb and Cr. However, there is a cross-component term from luma to a chroma component (i.e., CC-ALF Cb 422 and CC-ALF Cr 424). The outputs from the cross-component ALF are added (using adders 432 and 434 respectively) to the outputs from ALF Chroma 430.

Filtering in CC-ALF is accomplished by applying a linear, diamond shaped filter (e.g. filters 440 and 442 in FIG. 4B) to the luma channel. In FIG. 4B, a blank circle indicates a luma sample and a dot-filled circle indicate a chroma sample. One filter is used for each chroma channel, and the operation is expressed as:

$$Δ {I}_{i} ( x , y ) = {\sum }_{( {x}_{0} , {y}_{0} ) ∈ {S}_{i}} {I}_{0} ( {x}_{Y} + {x}_{0} , {y}_{Y} + {y}_{0} ) {c}_{i} ( {x}_{0} , {y}_{0} )$$

where (x, y) is chroma component i location being refined, (x_{Y}, y_{Y}) is the luma location based on (x, y), Sᵢ is filter support area in luma component, and cᵢ(x₀, y₀) represents the filter coefficients.

As shown in FIG. 4B, the luma filter support is the region collocated with the current chroma sample after accounting for the spatial scaling factor between the luma and chroma planes.

In the VVC reference software, CC-ALF filter coefficients are computed by minimizing the mean square error of each chroma channel with respect to the original chroma content. To achieve this, the VTM (VVC Test Model) algorithm uses a coefficient derivation process similar to the one used for chroma ALF. Specifically, a correlation matrix is derived, and the coefficients are computed using a Cholesky decomposition solver in an attempt to minimize a mean square error metric. In designing the filters, a maximum of 8 CC-ALF filters can be designed and transmitted per picture. The resulting filters are then indicated for each of the two chroma channels on a CTU basis.

Additional characteristics of CC-ALF include:
The design uses a 3×4 diamond shape with 8 taps.
Seven filter coefficients are transmitted in the APS (Adaptation Parameter Set).
Each of the transmitted coefficients has a 6-bit dynamic range and is restricted to power-of-2 values.
The eighth filter coefficient is derived at the decoder such that the sum of the filter coefficients is equal to 0.
An APS may be referenced in the slice header.
CC-ALF filter selection is controlled at CTU-level for each chroma component
Boundary padding for the horizontal virtual boundaries uses the same memory access pattern as luma ALF.

As an additional feature, the reference encoder can be configured to enable some basic subjective tuning through the configuration file. When enabled, the VTM attenuates the application of CC-ALF in regions that are coded with high QP and are either near mid-grey or contain a large amount of luma high frequencies. Algorithmically, this is accomplished by disabling the application of CC-ALF in CTUs where any of the following conditions are true:
The slice QP value minus 1 is less than or equal to the base QP value.
The number of chroma samples for which the local contrast is greater than (1<<(bitDepth−2))−1 exceeds the CTU height, where the local contrast is the difference between the maximum and minimum luma sample values within the filter support region.
More than a quarter of chroma samples are in the range between

$$( 1 << ( bitDepth - 1 ) ) - 16 and ( 1 << ( bitDepth - 1 ) ) + 16$$

The motivation for this functionality is to provide some assurance that CC-ALF does not amplify artefacts introduced earlier in the decoding path (This is largely due the fact that the VTM currently does not explicitly optimize for chroma subjective quality). It is anticipated that alternative encoder implementations may either not use this functionality or incorporate alternative strategies suitable for their encoding characteristics.

### Filter Parameters Signalling

ALF filter parameters are signalled in Adaptation Parameter Set (APS). In one APS, up to 25 sets of luma filter coefficients and clipping value indexes, and up to eight sets of chroma filter coefficients and clipping value indexes can be signalled. To reduce bits overhead, filter coefficients of different classification for luma component can be merged. In slice header, the indices of the APSs used for the current slice are signalled.

Clipping value indexes, which are decoded from the APS, allow determining clipping values using a table of clipping values for both luma and Chroma components. These clipping values are dependent of the internal bitdepth. More precisely, the clipping values are obtained by the following formula:

$$AlfClip = \{ round ( {2}^{B - α * n} ) for n ∈ [ 0 … , N - 1 ] \}$$

with B equal to the internal bitdepth, a is a pre-defined constant value equal to 2.35, and N equal to 4 which is the number of allowed clipping values in VVC. The AlfClip is then rounded to the nearest value with the format of power of 2.

In slice header, up to 7 APS indices can be signalled to specify the luma filter sets that are used for the current slice. The filtering process can be further controlled at CTB level. A flag is always signalled to indicate whether ALF is applied to a luma CTB. A luma CTB can choose a filter set among 16 fixed filter sets and the filter sets from APSs. A filter set index is signalled for a luma CTB to indicate which filter set is applied. The 16 fixed filter sets are pre-defined and hard-coded in both the encoder and the decoder.

For the chroma component, an APS index is signalled in slice header to indicate the chroma filter sets being used for the current slice. At CTB level, a filter index is signalled for each chroma CTB if there is more than one chroma filter set in the APS.

The filter coefficients are quantized with norm equal to 128. In order to restrict the multiplication complexity, a bitstream conformance is applied so that the coefficient value of the non-central position shall be in the range of −27 to 27−1, inclusive. The central position coefficient is not signalled in the bitstream and is considered as equal to 128.

### Adaptive Loop Filter in ECM

During the recent video standard development, more advanced ALF than the ALF in VVC has been disclosed. The status of the developed coding algorithm is described in ECM (Enhanced Compression Model) and updated during each meeting (e.g. ECM-6, Muhammed Coban, et. al., “Algorithm description of Enhanced Compression Model 6 (ECM 6)”, 27th Meeting, by teleconference, 13-22 Jul. 2022, Document: JVET-AA2025). The ALF filtering process according to ECM is described as follows.

### ALF Simplification

ALF gradient subsampling and ALF virtual boundary processing are removed. Block size for classification is reduced from 4×4 to 2×2. Filter size for both luma and chroma, for which ALF coefficients are signalled, is increased to 9×9.

ALF with Fixed Filters

To filter a luma sample, three different classifiers (C0, C1 and C2) and three different sets of filters (F0, F1 and F2) are used. Sets F0 and F1 contain fixed filters, with coefficients trained for classifiers C0 and C1. Coefficients of filters in F2 are signalled. Which filter from a set Fi is used for a given sample is decided by a class Cᵢ assigned to this sample using classifier Ci.

### Filtering

At first, two 13×13 diamond shape fixed filters F0 and F1 are applied to derive two intermediate samples R₀(x, y) and R₁(x, y). After that, F2 is applied to R₀(x, y), R₁(x, y), and neighbouring samples to derive a filtered sample as

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{21} {c}_{i} {g}_{i} ] ,$$

where f_{i,j} is the clipped difference between a neighbouring sample and current sample R(x, y) and gᵢ is the clipped difference between Rᵢ₋₂₀(x, y) and current sample. The filter coefficients cᵢ, i=0, . . . 21, are signalled.

### Classification

Based on directionality Dᵢ and activity Âᵢ, a class Cᵢ is assigned to each 2×2 block:

$${C}_{i} = {\hat{A}}_{i} * {M}_{D , i} + {D}_{i} ,$$

where M_{D,i} represents the total number of directionalities Dᵢ.

As in VVC, values of the horizontal, vertical, and two diagonal gradients are calculated for each sample using 1-D Laplacian. The sum of the sample gradients within a 4×4 window that covers the target 2×2 block is used for classifier C0 and the sum of sample gradients within a 12×12 window is used for classifiers C1 and C2. The sums of horizontal, vertical and two diagonal gradients are denoted, respectively, as

$${g}_{h}^{i} , {g}_{v}^{i} , {g}_{d 1}^{i} and {g}_{d 2}^{i} .$$

The directionality Dᵢ is determined by comparing

$${r}_{h , v}^{i} = \frac{max ( {g}_{h}^{i} , {g}_{v}^{i} )}{min ( {g}_{h}^{i} , {g}_{v}^{i} )} , {r}_{d 1 , d 2}^{i} = \frac{max ( {g}_{d 1}^{i} , {g}_{d 2}^{i} )}{min ( {g}_{d 1}^{i} , {g}_{d 2}^{i} )} ,$$

with a set of thresholds. The directionality D₂ is derived as in VVC using thresholds 2 and 4.5. For D₀ and D₁, horizontal/vertical edge strength

$${E}_{HV}^{i}$$

and diagonal edge strength

$${E}_{D}^{i}$$

are calculated first. Thresholds Th=[1.25, 1.5, 2, 3, 4.5, 8] are used. Edge strength

$${E}_{HV}^{i}$$

is 0 if

$${r}_{h , v}^{i} \leq Th [ 0 ] ;$$

otherwise,

$${E}_{HV}^{i}$$

is the maximum integer such that

$${r}_{h , v}^{i} > Th [ {E}_{HV}^{i} - 1 ] .$$

Edge strength

$${E}_{D}^{i}$$

is 0 if

$${r}_{d 1 , d 2}^{i} \leq Th [ 0 ] ;$$

otherwise,

$${E}_{D}^{i}$$

is the maximum integer such that

$${r}_{d 1 , d 2}^{i} > Th [ {E}_{D}^{i} - 1 ] .$$

### When

$${r}_{h , v}^{i} > {r}_{d 1 , d 2}^{i} ,$$

i.e., horizontal/vertical edges are dominant, the Dᵢ is derived by using Table 2A; otherwise, diagonal edges are dominant, the Dᵢ is derived by using Table 2B.

TABLE 2A
$Mapping of {E}_{D}^{i} and {E}_{HV}^{i} to {D}_{i}$

| | ${E}_{D}^{i}$ | | | | | | |
|---|---|---|---|---|---|---|---|
| ${E}_{HV}^{i}$ | 0 | 1 | 2 | 3 | 4 | 5 | 6 |
| 0 | 0 | 0 | 0 | 0 | 0 | 0 | 0 |
| 1 | 1 | 2 | 0 | 0 | 0 | 0 | 0 |
| 2 | 3 | 4 | 5 | 0 | 0 | 0 | 0 |
| 3 | 6 | 7 | 8 | 9 | 0 | 0 | 0 |
| 4 | 10 | 11 | 12 | 13 | 14 | 0 | 0 |
| 5 | 15 | 16 | 17 | 18 | 19 | 20 | 0 |
| 6 | 21 | 22 | 23 | 24 | 25 | 26 | 27 |

TABLE 2B
$Mapping of {E}_{D}^{i} and {E}_{HV}^{i} to {D}_{i}$

| | ${E}_{HV}^{i}$ | | | | | | |
|---|---|---|---|---|---|---|---|
| ${E}_{D}^{i}$ | 0 | 1 | 2 | 3 | 4 | 5 | 6 |
| 0 | 28 | 0 | 0 | 0 | 0 | 0 | 0 |
| 1 | 29 | 30 | 0 | 0 | 0 | 0 | 0 |
| 2 | 31 | 32 | 33 | 0 | 0 | 0 | 0 |
| 3 | 34 | 35 | 36 | 37 | 0 | 0 | 0 |
| 4 | 38 | 39 | 40 | 41 | 42 | 0 | 0 |
| 5 | 43 | 44 | 45 | 46 | 47 | 48 | 0 |
| 6 | 49 | 50 | 51 | 52 | 53 | 54 | 55 |

To obtain Âᵢ, the sum of vertical and horizontal gradients Aᵢ is mapped to the range of 0 to n, where n is equal to 4 for Ā₂ and 15 for Ā₀ and Â₁.

In an ALF_APS, up to 4 luma filter sets are signalled, each set may have up to 25 filters.

### Alternative 2×2 ALF Classifier

Classification in ALF is extended with an additional alternative classifier. For a signalled luma filter set, a flag is signalled to indicate whether the alternative classifier is applied. Geometrical transformation is not applied to the alternative band classifier. When the band-based classifier is applied, the sum of sample values of a 2×2 luma block is calculated at first. Then the class index is calculated as below,

$$class\_index = ( sum * 25 ) ≫ ( sample bit depth + 2 ) .$$

### Residual Based Classifier

A third classifier based on luma residual sample values. For each 2×2 luma block, the sum of absolute values of the residual samples in a neighbouring 8×8 window is calculated, and the class index is derived as:

$$classIdx = sum ≫ ( sample bit depth - 4 ) .$$

The value of classIdx is in the range of 0 to 24, same as in ECM-8.0. The classifier usage is signalled for each luma filter set in APS.

ALF with Residual Samples

The residual samples are used as additional inputs to the ALF. A filtered sample is derived as:

$$\tilde{R} ( x , y ) = R ( x , y ) + [ {\sum }_{i = 0}^{19} {c}_{i} ( {f}_{i , 0} + {f}_{i , 1} ) ] + [ {\sum }_{i = 20}^{25} {c}_{i} ( {g}_{i , 0} + {g}_{i , 1} ) ] + [ {\sum }_{i = 26}^{27} {c}_{i} ( {h}_{i , 0} + {h}_{i , 1} ) ] + [ {\sum }_{i = 28}^{29} {c}_{i} {g}_{i} ] + [ {\sum }_{i = 30}^{30} {c}_{i} {h}_{i} ] + [ {\sum }_{i = 31}^{31} {c}_{i} {r}_{i} ] + [ {\sum }_{i = 32}^{32} {c}_{i} {rFilterd}_{i} ]$$

where rᵢ is the clipped neighbouring residual sample value and rFilteredᵢ is the clipped residual sample filtered by the fixed-filter. For residual samples, the fixed filter reuses the offline fixed filter trained for reconstruction after SAO.

In the present invention, techniques to design chroma ALF and/or CCALF by incorporating residual inputs are disclosed in order to improve performance.

### BRIEF SUMMARY OF THE INVENTION

Method and apparatus to use residual inputs for chroma ALF and/or CCALF are disclosed. According to this method, reconstructed data associated with a current block comprising a luma block and one or more chroma blocks are received. a chroma ALF (Adaptive Loop Filter), a Cross-Component ALF (CCALF), or both are determined, wherein the chroma ALF, the CCALF, or both comprise at least one first filter tap associated with a luma residual sample, at least one second filter tap associated with a chroma residual sample, or both. One or more filtered chroma samples are derived by applying the chroma ALF, the CCALF or both to the luma block, said one or more chroma blocks, or both. Said one or more filtered chroma samples are provided.

In one embodiment, at least one first coefficient for said at least one first filter tap, at least one second coefficient for said at least one second filter tap, or both are signalled in a bitstream or parsed from the bitstream.

In one embodiment, one or more luma residual samples, one or more chroma residual samples, or both are used in a classification process for the chroma ALF, the CCALF or both.

In one embodiment, the luma residual sample, the chroma residual sample, or both are processed by a fixed filter prior to said applying the chroma ALF, the CCALF or both. In one embodiment, the fixed filter is selected based on ALF classification result. In another embodiment, the fixed filter is predefined.

In one embodiment, the luma residual sample, the chroma residual sample, or both are processed by a Cross-Component Convolutional Model (CCCM) prior to said applying the chroma ALF, the CCALF or both. In one embodiment, a convolutional model for mapping between one or more luma residual samples and one or more chroma residual samples in a region using a linear regression process. In one embodiment, when the chroma ALF is applied to derive a current filtered chroma sample, a mapped chroma sample is derived by applying the CCCM to one or more corresponding luma residual samples, and the mapped chroma sample is used with a signalled coefficient for said at least one first filter tap of the chroma ALF.

In one embodiment, when the CCALF is applied to derive a current filtered chroma sample, the CCALF comprises one or more first filter taps associated with one or more luma residual samples.

### BRIEF DESCRIPTION OF THE DRAWINGS

FIG. 1A illustrates an exemplary adaptive Inter/Intra video encoding system incorporating loop processing.

FIG. 1B illustrates a corresponding decoder for the encoder in FIG. 1A.

FIG. 2 illustrates the ALF filter shapes for the chroma (left) and luma (right) components.

FIGS. 3A-D illustrates the subsampled Laplacian calculations for gᵥ (3A), gₕ (3B), g_{d1} (3C) and g_{d2} (3D).

FIG. 4A illustrates the placement of CC-ALF with respect to other loop filters.

FIG. 4B illustrates a diamond shaped filter for the chroma samples.

FIG. 5 illustrates a flowchart of an exemplary video coding system using one or more residual samples as input taps for chroma ALF or CCALF according to an embodiment of the present invention.

### DETAILED DESCRIPTION OF THE INVENTION

It will be readily understood that the components of the present invention, as generally described and illustrated in the figures herein, may be arranged and designed in a wide variety of different configurations. Thus, the following more detailed description of the embodiments of the systems and methods of the present invention, as represented in the figures, is not intended to limit the scope of the invention, as claimed, but is merely representative of selected embodiments of the invention. References throughout this specification to “one embodiment,” “an embodiment,” or similar language mean that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that the invention can be practiced without one or more of the specific details, or with other methods, components, etc. In other instances, well-known structures, or operations are not shown or described in detail to avoid obscuring aspects of the invention. The illustrated embodiments of the invention will be best understood by reference to the drawings, wherein like parts are designated by like numerals throughout. The following description is intended only by way of example, and simply illustrates certain selected embodiments of apparatus and methods that are consistent with the invention as claimed herein.

### ALF Residual Samples for Chroma

In one embodiment, luma and/or chroma residual samples are utilized in chroma ALF filtering process with signalled coefficients. In such embodiment, one or more of the following steps can be applied:
Chroma ALF filtering process by signalled coefficients with luma residual samples
Chroma ALF filtering process by signalled coefficients with chroma residual samples
Chroma ALF filtering process by signalled coefficients with luma residual samples filtered by a fixed filter
Chroma ALF filtering process by signalled coefficients with chroma residual samples filtered by a fixed filter,
The fixed filter can be a filter with filter selection based on the ALF classification result or can be a pre-defined general filter without filter selection, such as Gaussian filter or mean filter.
Chroma ALF filtering process by signalled coefficients with luma residual samples filtered by a Cross-Component Convolutional Model (CCCM)
Specifically, a convolutional model for mapping between residual luma samples and chroma samples in a region is built by linear regression. While processing a current sample, a mapped chroma sample is derived by applying the model to one or more corresponding luma residual samples, and the derived sample is used with a signalled coefficient for chroma ALF filtering.

In another embodiment, luma and/or chroma residual samples are utilized in the chroma ALF classification process. In such embodiment, one or more of the following steps can be applied:
Chroma ALF classification process with luma residual samples
Chroma ALF classification process with chroma residual samples
Chroma ALF classification process with luma residual samples filtered by a fixed filter
Chroma ALF classification process with chroma residual samples filtered by a fixed filter
The fixed filter can be a filter with filter selection based on another ALF classification result or can be a pre-defined general filter without filter selection, such as Gaussian filter or mean filter.
Chroma ALF classification process with luma residual samples filtered by a Cross-Component Convolutional Model (CCCM)
Specifically, a convolutional model for mapping between residual luma samples and chroma samples in a region is built by linear regression. While processing a current sample, a mapped chroma sample is derived by applying the model to one or more corresponding luma residual samples, and the derived sample is used for chroma ALF classification.

In one embodiment, luma and/or chroma residual samples are utilized in the chroma CCALF filtering process with signalled coefficients. In such embodiment, one or more of the following steps can be applied:
CCALF filtering process by signalled coefficients with luma residual samples
CCALF filtering process by signalled coefficients with chroma residual samples
CCALF filtering process by signalled coefficients with luma residual samples filtered by a fixed filter
CCALF filtering process by signalled coefficients with chroma residual samples filtered by a fixed filter
The fixed filter can be a filter with filter selection based on the ALF classification result or can be a pre-defined general filter without filter selection, such as Gaussian filter or mean filter.
CCALF filtering process by signalled coefficients with luma residual samples filtered by a Cross-Component Convolutional Model (CCCM)
Specifically, a convolutional model for mapping between residual luma samples and chroma samples in a region is built by linear regression. While processing a current sample, a mapped chroma sample is derived by applying the model to one or more corresponding luma residual samples, and the derived sample is used with a signalled coefficient for CCALF filtering.

In another embodiment, luma and/or chroma residual samples are utilized in chroma CCALF classification process. In such embodiment, one or more of the following steps can be applied:
CCALF classification process with luma residual samples
CCALF classification process with chroma residual samples
CCALF classification process with luma residual samples filtered by a fixed filter
CCALF classification process with chroma residual samples filtered by a fixed filter
The fixed filter can be a filter with filter selection based on another ALF classification result or can be a pre-defined general filter without filter selection, such as Gaussian filter or mean filter.
CCALF classification process with luma residual samples filtered by a Cross-Component Convolutional Model (CCCM)
Specifically, a convolutional model for mapping between residual luma samples and chroma samples in a region is built by linear regression. While processing a current sample, a mapped chroma sample is derived by applying the model to one or more corresponding luma residual samples, and the derived sample is used for CCALF classification.

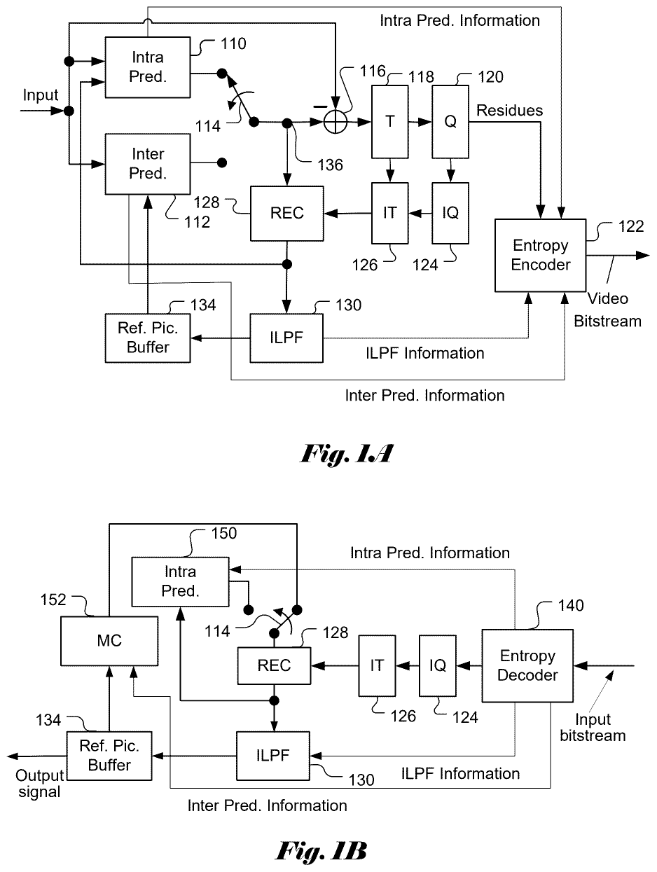

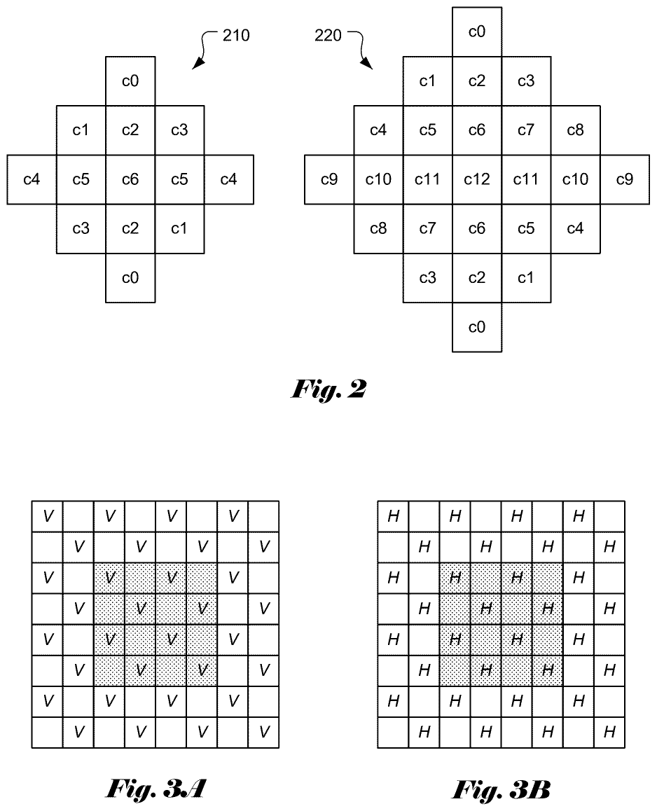

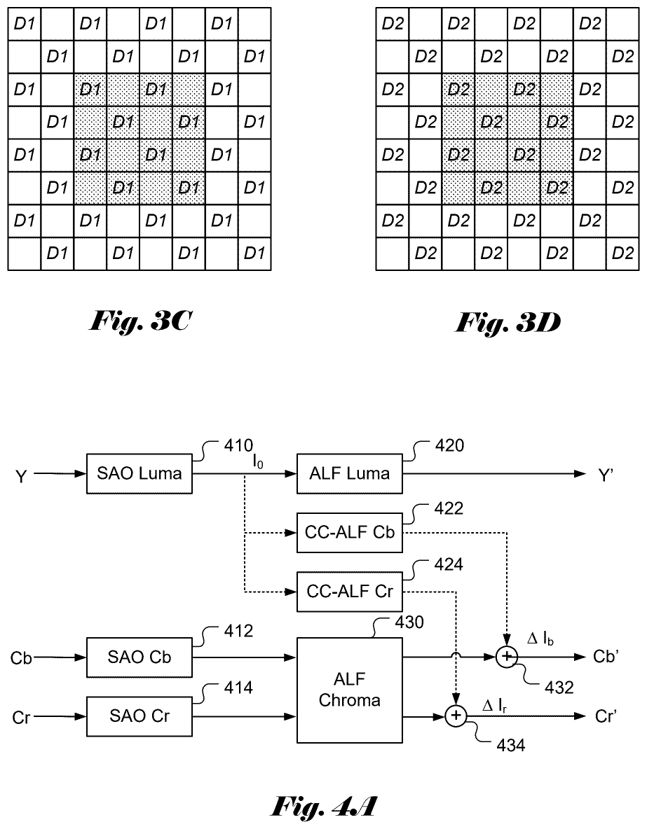

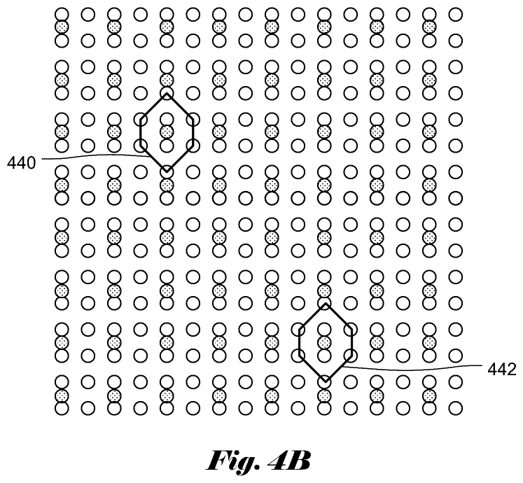

The foregoing proposed methods can be implemented in encoders and/or decoders. For example, the proposed method can be implemented in an in-loop filtering module of an encoder, and/or an in-loop filtering module of a decoder. For example, the chroma ALF/CCALF filtering process with residual samples as input taps as described above can be implemented in Inter Prediction/Intra prediction/In-Loop Filter units (e.g. Intra Pred. 110/Inter Pred. 112/In-Loop Filter (ILPF) 130 in FIG. 1A and Intra Pred. 150/MC 152/In-Loop Filter (ILPF) 130 in FIG. 1B) in an encoder or decoder. Any of the proposed methods can also be implemented as circuits coupled to the inter/intra/in-loop filter units at the decoder or the encoder. However, the decoder or encoder may also use additional processing unit to implement the required processing. While the Intra Pred./Inter Pred./In-Loop Filter units are shown as individual processing units, they may correspond to executable software or firmware codes stored on a media, such as hard disk or flash memory, for a CPU (Central Processing Unit) or programmable devices (e.g. DSP (Digital Signal Processor) or FPGA (Field Programmable Gate Array)).

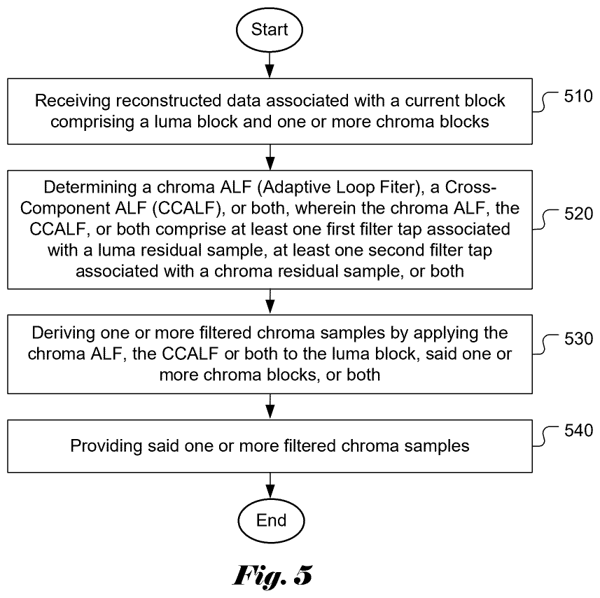

FIG. 5 illustrates a flowchart of an exemplary video coding system using one or more residual samples as input taps for chroma ALF or CCALF according to an embodiment of the present invention. The steps shown in the flowchart may be implemented as program codes executable on one or more processors (e.g., one or more CPUs) at the encoder side or decoder side. The steps shown in the flowchart may also be implemented based hardware such as one or more electronic devices or processors arranged to perform the steps in the flowchart. According to this method, reconstructed data associated with a current block comprising a luma block and one or more chroma blocks are received in step 510. a chroma ALF (Adaptive Loop Filter), a Cross-Component ALF (CCALF), or both are determined in step 520, wherein the chroma ALF, the CCALF, or both comprise at least one first filter tap associated with a luma residual sample, at least one second filter tap associated with a chroma residual sample, or both. One or more filtered chroma samples are derived in step 530 by applying the chroma ALF, the CCALF or both to the luma block, said one or more chroma blocks, or both. Said one or more filtered chroma samples are provided in step 540.

The flowchart shown is intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of processing colour pictures, the method comprising:
receiving reconstructed data associated with a current block comprising a luma block and one or more chroma blocks;
determining a chroma ALF (Adaptive Loop Filter), a Cross-Component ALF (CCALF), or both, wherein the chroma ALF, the CCALF, or both comprise at least one first filter tap associated with a luma residual sample, at least one second filter tap associated with a chroma residual sample, or both;
deriving one or more filtered chroma samples by applying the chroma ALF, the CCALF or both to the luma block, said one or more chroma blocks, or both; and
providing said one or more filtered chroma samples.

2. The method of claim 1, wherein at least one first coefficient for said at least one first filter tap, at least one second coefficient for said at least one second filter tap, or both are signalled in a bitstream or parsed from the bitstream.

3. The method of claim 1, wherein one or more luma residual samples, one or more chroma residual samples, or both are used in a classification process for the chroma ALF, the CCALF or both.

4. The method of claim 1, wherein the luma residual sample, the chroma residual sample, or both are processed by a fixed filter prior to said applying the chroma ALF, the CCALF or both.

5. The method of claim 4, wherein the fixed filter is selected based on ALF classification result.

6. The method of claim 4, wherein the fixed filter is predefined.

7. The method of claim 1, wherein the luma residual sample, the chroma residual sample, or both are processed by a Cross-Component Convolutional Model (CCCM) prior to said applying the chroma ALF, the CCALF or both.

8. The method of claim 7, wherein a convolutional model for mapping between one or more luma residual samples and one or more chroma residual samples in a region using a linear regression process.

9. The method of claim 8, wherein when the chroma ALF is applied to derive a current filtered chroma sample, a mapped chroma sample is derived by applying the CCCM to one or more corresponding luma residual samples, and the mapped chroma sample is used with a signalled coefficient for said at least one first filter tap of the chroma ALF.

10. The method of claim 1, wherein when the CCALF is applied to derive a current filtered chroma sample, the CCALF comprises one or more first filter taps associated with one or more luma residual samples.

11. An apparatus for processing of coded video, the apparatus comprising one or more electronics or processors arranged to:
receive reconstructed data associated with a current block comprising a luma block and one or more chroma blocks;
determine a chroma ALF (Adaptive Loop Filter), a Cross-Component ALF (CCALF), or both, wherein the chroma ALF, the CCALF, or both comprise at least one first filter tap associated with a luma residual sample, at least one second filter tap associated with a chroma residual sample, or both;
derive one or more filtered chroma samples by applying the chroma ALF, the CCALF or both to the luma block, said one or more chroma blocks, or both; and
provide said one or more filtered chroma samples.
